(19) United States
(12) Patent Application Publication
(10) Pub. No.: US 2025/0299053 A1
(43) Pub. Date: Sep. 25, 2025

(54) ADAPTIVE PROMPT VIRTUALIZATION

(71) Applicant: International Business Machines Corporation, Armonk, NY (US)

(72) Inventors: Gennaro Anthony Cuomo, Raleigh, NC (US); Blaine H. Dolph, Western Springs, IL (US); Luis Fernando Munoz, Centennial, CO (US); Vijay Kumar Ananthapur Bache, Bangalore (IN); Matthew Candy, Hursley (GB); Christopher Hay, Great Horkesley (GB)

(21) Appl. No.: 18/612,073

(22) Filed: Mar. 21, 2024

(51) Int. Cl. G06N 3/091

(52) U.S. Cl. CPC G06N 3/091

(57) ABSTRACT

Embodiments of the present invention provide computer-implemented methods, computer program product, and computer systems. One or more processors analyze user prompts using one or more natural language understanding techniques. One or more processors then enrich the user prompts by integrating contextual data from user interaction history and adapt the enriched user prompts to align with characteristics of Large Language Models (LLMs) and Application Programming Interfaces (API) requirements of the LLMs.

### BACKGROUND

The present invention relates generally to large language models, and more particularly to prompt virtualization.

Large language models (LLM) are large deep learning models that are pre-trained on vast amounts of data. Typically, the underlying transformer is a set of neural networks that consist of an encoder and a decoder with self-attention capabilities. The encoder and decoder extract meanings from a sequence of text and understand the relationships between words and phrases in it.

Transformer LLMs are capable of unsupervised training, although a more precise explanation is that transformers perform self-learning. It is through this process that transformers learn to understand basic grammar, languages, and knowledge. Unlike earlier recurrent neural networks (RNN) that sequentially process inputs, transformers process entire sequences in parallel. This allows the data scientists to use GPUs for training transformer-based LLMs, significantly reducing the training time.

### SUMMARY

According to an aspect of the present invention, there is provided a computer-implemented method, a computer program product, and a computer system. The computer-implemented method includes: analyzing user prompts using one or more natural language understanding techniques; enriching the user prompts by integrating contextual data from user interaction history; and adapting the enriched user prompts to align with characteristics of Large Language Models (LLMs) and Application Programming Interfaces (API) requirements of the LLMs.

The computer program product includes: one or more computer readable storage media and program instructions stored on the one or more computer readable storage media, the program instructions including program instructions to analyze user prompts using one or more natural language understanding techniques; program instructions to enrich the user prompts by integrating contextual data from user interaction history; and program instructions to adapt the enriched user prompts to align with characteristics of Large Language Models (LLMs) and Application Programming Interfaces (API) requirements of the LLMs.

The computer system includes one or more computer processors; one or more computer readable storage media; and program instructions stored on the one or more computer readable storage media for execution by at least one of the one or more computer processors. The program instructions include program instructions to analyze user prompts using one or more natural language understanding techniques; program instructions to enrich the user prompts by integrating contextual data from user interaction history; and program instructions to adapt the enriched user prompts to align with characteristics of Large Language Models (LLMs) and Application Programming Interfaces (API) requirements of the LLMs.

### BRIEF DESCRIPTION OF THE DRAWINGS

Preferred embodiments of the present invention will now be described, by way of example only, with reference to the following drawings, in which:

FIG. 1 depicts a block diagram of a computing environment, in accordance with an embodiment of the present invention;

FIG. 2 depicts a block diagram of certain components of a virtualization manager, in accordance with an embodiment of the present invention;

FIG. 3 is a flowchart depicting operational steps for virtualizing a received prompt, in accordance with an embodiment of the present invention;

FIG. 4 is a flowchart depicting operational steps for automatically selecting a model, in accordance with an embodiment of the present invention;

FIG. 5 is a flowchart depicting alternate operational steps for virtualizing a received prompt, in accordance with an embodiment of the present invention; and

FIG. 6 is a block diagram of an alternate computing environment, in accordance with an embodiment of the present invention.

### DETAILED DESCRIPTION

According to an aspect of the invention, there is provided a computer-implemented method that includes analyzing user prompts using one or more natural language understanding techniques. The computer-implemented method further includes enriching the user prompts by integrating contextual data from user interaction history. The computer-implemented method further includes adapting the enriched user prompts to align with characteristics of Large Language Models (LLMs) and Application Programming Interfaces (API) requirements of the LLMs. Such an aspect of the invention has the technical advantage of virtualizing prompts to be effective across multiple LLMs, focusing on prompt enrichment and adaptation for optimal model-agnostic responses.

Additionally or alternatively, the computer-implemented method that includes analyzing user prompts using one or more natural language understanding techniques, enriching the user prompts by integrating contextual data from user interaction history, and adapting the enriched prompts to align with characteristics of Large Language Models (LLMs) and Application Programming Interfaces (API) requirements of the LLMs can further include collecting received user prompts and contextual information associated with the received user prompts and tailoring the received user prompts for a respective LLM of the respective LLMs based on characteristics of each respective LLM. Collecting received user prompts and contextual information has the technical advantage of can provide contextual information of the user's inquiry patterns and preferences which can be used to enrich prompts to yield better results.

Additionally or alternatively, the computer-implemented method that includes analyzing user prompts using one or more natural language understanding techniques, enriching the user prompts by integrating contextual data from user interaction history, and adapting the enriched prompts to align with characteristics of Large Language Models (LLMs) and Application Programming Interfaces (API) requirements of the LLMs, collecting received user prompts and contextual information associated with the received user prompts, and tailoring the received user prompts for a respective LLM of the respective LLMs based on characteristics of each respective LLM can further include formatting the tailored user prompts to align with the respective LLM. Formatting the tailored user prompts to align with the respective LLM has the technical effect of maximizing the LLMs response efficiency and quality.

Additionally or alternatively, the computer-implemented method that includes analyzing user prompts using one or more natural language understanding techniques, enriching the user prompts by integrating contextual data from user interaction history, and adapting the enriched prompts to align with characteristics of Large Language Models (LLMs) and Application Programming Interfaces (API) requirements of the LLMs, collecting received user prompts and contextual information associated with the received user prompts, and tailoring the received user prompts for a respective LLM of the respective LLMs based on characteristics of each respective LLM can further include categorizing the enriched user prompts based on its characteristics into specific domains and styles using natural language processing, matching the categorized prompts with a subset of LLMs of the respective LLMs by querying a model behavior database, and algorithmically selecting an optimal LLM from the subset of LLMs based on the user's prompts. Categorizing the enriched user prompts has the technical effect of improving future queries by building a robust database that embodiments of the present invention can utilize. Matching the categorized prompts with a subset of LLMs and algorithmically selecting an optimal LLM has the technical effect of producing better results by optimizing a prompt to better leverage a model's strengths.

Additionally or alternatively, the computer-implemented method that includes analyzing user prompts using one or more natural language understanding techniques, enriching the user prompts by integrating contextual data from user interaction history, and adapting the enriched prompts to align with characteristics of Large Language Models (LLMs) and Application Programming Interfaces (API) requirements of the LLMs, collecting received user prompts and contextual information associated with the received user prompts, tailoring the received user prompts for a respective LLM of the respective LLMs based on characteristics of each respective LLM; categorizing the enriched user prompts based on its characteristics into specific domains and styles using natural language processing, matching the categorized prompts with a subset of LLMs of the respective LLMs by querying a model behavior database, algorithmically selecting an optimal LLM from the subset of LLMs based on the user's prompts; can further include automatically selecting an optimal Large Language Model from the LLMs based on user prompts, contextual information associated with the user prompts, and characteristics of the enriched user prompt. Automatically selecting an optimal LLM has the technical effect of maximizing response quality by considering each model's specific strengths and past performance data.

Additionally or alternatively, the computer-implemented method that includes analyzing user prompts using one or more natural language understanding techniques, enriching the user prompts by integrating contextual data from user interaction history, and adapting the enriched prompts to align with characteristics of Large Language Models (LLMs) and Application Programming Interfaces (API) requirements of the LLMs can further include collecting received user prompts and contextual information associated with the received user prompts, tailoring the received user prompts for a respective LLM of the respective LLMs based on characteristics of each respective LLM, and evaluating effectiveness of the tailored user prompts by integrating a feedback loop. Evaluating effectiveness of the tailored user prompts by integrating a feedback loop has the technical effect of refining model selection criteria based on real-world usage patterns and effectiveness, thereby enhancing the overall interaction experience with different LLMs.

Additionally or alternatively, the computer-implemented method that includes analyzing user prompts using one or more natural language understanding techniques, enriching the user prompts by integrating contextual data from user interaction history, and adapting the enriched prompts to align with characteristics of Large Language Models (LLMs) and Application Programming Interfaces (API) requirements of the LLMs can further include collecting received user prompts and contextual information associated with the received user prompts, tailoring the received user prompts for a respective LLM of the respective LLMs based on characteristics of each respective LLM, evaluating effectiveness of the tailored user prompts by integrating a feedback loop, and updating a model behavior database based on context provided by users and the evaluated effectiveness of the tailored user prompts. Updating a model behavior database has the technical effect of refining the selection algorithm.

According to an aspect of the invention, there is provided a computer program product that includes one or more computer readable storage media and program instructions stored on the one or more computer readable storage media that include program instructions to analyze user prompts using one or more natural language understanding techniques. The computer program product further includes program instructions to enrich the user prompts by integrating contextual data from user interaction history. The computer program product further includes program instructions to adapt the enriched prompts to align with characteristics of Large Language Models (LLMs) and Application Programming Interfaces (API) requirements of the LLMs. Such an aspect of the invention has the technical advantage of virtualizing prompts to be effective across multiple LLMs, focusing on prompt enrichment and adaptation for optimal model-agnostic responses.

Additionally or alternatively, the computer program product that includes program instructions to analyze user prompts using one or more natural language understanding techniques, program instructions to enrich the user prompts by integrating contextual data from user interaction history, and program instructions to adapt the enriched prompts to align with characteristics of Large Language Models (LLMs) and Application Programming Interfaces (API) requirements of the LLMs can further include program instructions to collect received user prompts and contextual information associated with the received user prompts and program instructions to tailor the received user prompts for a respective LLM of the respective LLMs based on characteristics of each respective LLM. Collecting received user prompts and contextual information has the technical advantage of can provide contextual information of the user's inquiry patterns and preferences which can be used to enrich prompts to yield better results.

Additionally or alternatively, the computer program product that includes program instructions to analyze user prompts using one or more natural language understanding techniques, program instructions to enrich the user prompts by integrating contextual data from user interaction history, program instructions to adapting the enriched prompts to align with characteristics of Large Language Models (LLMs) and Application Programming Interfaces (API) requirements of the LLMs, collecting received user prompts and contextual information associated with the received user prompts, tailoring the received user prompts for a respective LLM of the respective LLMs based on characteristics of each respective LLM can further include program instructions to format the tailored user prompts to align with the respective LLM. Formatting the tailored user prompts to align with the respective LLM has the technical effect of maximizing the LLMs response efficiency and quality.

Additionally or alternatively, the computer program product that includes program instructions to analyze user prompts using one or more natural language understanding techniques, program instructions to enrich the user prompts by integrating contextual data from user interaction history, and program instructions to adapt the enriched prompts to align with characteristics of Large Language Models (LLMs) and Application Programming Interfaces (API) requirements of the LLMs, program instructions to collect received user prompts and contextual information associated with the received user prompts, and program instructions to tailor the received user prompts for a respective LLM of the respective LLMs based on characteristics of each respective LLM can further include program instructions to categorize the enriched user prompts based on its characteristics into specific domains and styles using natural language processing, program instructions to match the categorized prompts with a subset of LLMs of the respective LLMs by querying a model behavior database, and program instructions to algorithmically select an optimal LLM from the subset of LLMs based on the user's prompts. Categorizing the enriched user prompts has the technical effect of improving future queries by building a robust database that embodiments of the present invention can utilize. Matching the categorized prompts with a subset of LLMs and algorithmically selecting an optimal LLM has the technical effect of producing better results by optimizing a prompt to better leverage a model's strengths.

Additionally or alternatively, the computer program product that includes program instructions to program instructions to analyze user prompts using one or more natural language understanding techniques, program instructions to enrich the user prompts by integrating contextual data from user interaction history, program instructions to adapt the enriched prompts to align with characteristics of Large Language Models (LLMs) and Application Programming Interfaces (API) requirements of the LLMs, program instructions to collect received user prompts and contextual information associated with the received user prompts, program instructions to tailor the received user prompts for a respective LLM of the respective LLMs based on characteristics of each respective LLM; categorizing the enriched user prompts based on its characteristics into specific domains and styles using natural language processing, program instructions to match the categorized prompts with a subset of LLMs of the respective LLMs by querying a model behavior database, program instructions to algorithmically select an optimal LLM from the subset of LLMs based on the user's prompts; can further include program instructions to automatically select an optimal Large Language Model from the LLMs based on user prompts, contextual information associated with the user prompts, and characteristics of the enriched user prompt. Automatically selecting an optimal LLM has the technical effect of maximizing response quality by considering each model's specific strengths and past performance data.

Additionally or alternatively, the computer program product that includes program instructions to analyze user prompts using one or more natural language understanding techniques, program instructions to enrich the user prompts by integrating contextual data from user interaction history, and program instructions to adapt the enriched prompts to align with characteristics of Large Language Models (LLMs) and Application Programming Interfaces (API) requirements of the LLMs can further include program instructions to collect received user prompts and contextual information associated with the received user prompts, program instructions to tailor the received user prompts for a respective LLM of the respective LLMs based on characteristics of each respective LLM, and program instructions to evaluate effectiveness of the tailored user prompts by integrating a feedback loop. Evaluating effectiveness of the tailored user prompts by integrating a feedback loop has the technical effect of refining model selection criteria based on real-world usage patterns and effectiveness, thereby enhancing the overall interaction experience with different LLMs.

Additionally or alternatively, the computer program product that includes program instructions to analyze user prompts using one or more natural language understanding techniques, program instructions to enrich the user prompts by integrating contextual data from user interaction history, and program instructions to adapt the enriched prompts to align with characteristics of Large Language Models (LLMs) and Application Programming Interfaces (API) requirements of the LLMs can further include program instructions to collect received user prompts and contextual information associated with the received user prompts, program instructions to tailor the received user prompts for a respective LLM of the respective LLMs based on characteristics of each respective LLM, evaluating effectiveness of the tailored user prompts by integrating a feedback loop, and program instructions to update a model behavior database based on context provided by users and the evaluated effectiveness of the tailored user prompts. Updating a model behavior database has the technical effect of refining the selection algorithm.

According to an aspect of the invention, there is provided a computer system that includes one or more computer processors; one or more computer readable storage media and program instructions stored on the one or more computer readable storage media for execution by at least one of the one or more computer processors. The program instructions to analyze user prompts using one or more natural language understanding techniques. The computer program product further includes program instructions to enrich the user prompts by integrating contextual data from user interaction history. The computer program product further includes program instructions to adapt the enriched user prompts to align with characteristics of Large Language Models (LLMs) and Application Programming Interfaces (API) requirements of the LLMs. Such an aspect of the invention has the technical advantage of virtualizing prompts to be effective across multiple LLMs, focusing on prompt enrichment and adaptation for optimal model-agnostic responses.

Additionally or alternatively, the computer system that includes program instructions to analyze user prompts using one or more natural language understanding techniques, program instructions to enrich the user prompts by integrating contextual data from user interaction history, and program instructions to adapt the enriched prompts to align with characteristics of Large Language Models (LLMs) and Application Programming Interfaces (API) requirements of the LLMs can further include program instructions to collect received user prompts and contextual information associated with the received user prompts and program instructions to tailor the received user prompts for a respective LLM of the respective LLMs based on characteristics of each respective LLM. Collecting received user prompts and contextual information has the technical advantage of can provide contextual information of the user's inquiry patterns and preferences which can be used to enrich prompts to yield better results.

Additionally or alternatively, the computer system that includes program instructions to analyze user prompts using one or more natural language understanding techniques, program instructions to enrich the user prompts by integrating contextual data from user interaction history, program instructions to adapting the enriched prompts to align with characteristics of Large Language Models (LLMs) and Application Programming Interfaces (API) requirements of the LLMs, collecting received user prompts and contextual information associated with the received user prompts, tailoring the received user prompts for a respective LLM of the respective LLMs based on characteristics of each respective LLM can further include program instructions to format the tailored user prompts to align with the respective LLM. Formatting the tailored user prompts to align with the respective LLM has the technical effect of maximizing the LLMs response efficiency and quality.

Additionally or alternatively, the computer system that includes program instructions to analyze user prompts using one or more natural language understanding techniques, program instructions to enrich the user prompts by integrating contextual data from user interaction history, and program instructions to adapt the enriched prompts to align with characteristics of Large Language Models (LLMs) and Application Programming Interfaces (API) requirements of the LLMs, program instructions to collect received user prompts and contextual information associated with the received user prompts, and program instructions to tailor the received user prompts for a respective LLM of the respective LLMs based on characteristics of each respective LLM can further include program instructions to categorize the enriched user prompts based on its characteristics into specific domains and styles using natural language processing, program instructions to match the categorized prompts with a subset of LLMs of the respective LLMs by querying a model behavior database, and program instructions to algorithmically select an optimal LLM from the subset of LLMs based on the user's prompts. Categorizing the enriched user prompts has the technical effect of improving future queries by building a robust database that embodiments of the present invention can utilize. Matching the categorized prompts with a subset of LLMs and algorithmically selecting an optimal LLM has the technical effect of producing better results by optimizing a prompt to better leverage a model's strengths.

Additionally or alternatively, the computer system that includes program instructions to program instructions to analyze user prompts using one or more natural language understanding techniques, program instructions to enrich the user prompts by integrating contextual data from user interaction history, program instructions to adapt the enriched prompts to align with characteristics of Large Language Models (LLMs) and Application Programming Interfaces (API) requirements of the LLMs, program instructions to collect received user prompts and contextual information associated with the received user prompts, program instructions to tailor the received user prompts for a respective LLM of the respective LLMs based on characteristics of each respective LLM; categorizing the enriched user prompts based on its characteristics into specific domains and styles using natural language processing, program instructions to match the categorized prompts with a subset of LLMs of the respective LLMs by querying a model behavior database, program instructions to algorithmically select an optimal LLM from the subset of LLMs based on the user's prompts; can further include program instructions to automatically select an optimal Large Language Model from the LLMs based on user prompts, contextual information associated with the user prompts, and characteristics of the enriched user prompt. Automatically selecting an optimal LLM has the technical effect of maximizing response quality by considering each model's specific strengths and past performance data.

Additionally or alternatively, the computer system that includes program instructions to analyze user prompts using one or more natural language understanding techniques, program instructions to enrich the user prompts by integrating contextual data from user interaction history, and program instructions to adapt the enriched prompts to align with characteristics of Large Language Models (LLMs) and Application Programming Interfaces (API) requirements of the LLMs can further include program instructions to collect received user prompts and contextual information associated with the received user prompts, program instructions to tailor the received user prompts for a respective LLM of the respective LLMs based on characteristics of each respective LLM, and program instructions to evaluate effectiveness of the tailored user prompts by integrating a feedback loop. Evaluating effectiveness of the tailored user prompts by integrating a feedback loop has the technical effect of refining model selection criteria based on real-world usage patterns and effectiveness, thereby enhancing the overall interaction experience with different LLMs.

Additionally or alternatively, the computer system that includes program instructions to analyze user prompts using one or more natural language understanding techniques, program instructions to enrich the user prompts by integrating contextual data from user interaction history, and program instructions to adapt the enriched prompts to align with characteristics of Large Language Models (LLMs) and Application Programming Interfaces (API) requirements of the LLMs can further include program instructions to collect received user prompts and contextual information associated with the received user prompts, program instructions to tailor the received user prompts for a respective LLM of the respective LLMs based on characteristics of each respective LLM, evaluating effectiveness of the tailored user prompts by integrating a feedback loop, and program instructions to update a model behavior database based on context provided by users and the evaluated effectiveness of the tailored user prompts. Updating a model behavior database has the technical effect of refining the selection algorithm.

Embodiments of the present invention recognize that Large Language Models (LLMs) have become integral in diverse applications, from customer service to content generation. Embodiments of the present invention further recognize that the efficacy of their responses heavily relies on the quality of the prompts provided. Crafting an effective prompt requires a thorough understanding of each LLM's unique behaviors, strengths, and limitations, a task often complex and demanding for users.

Embodiments of the present invention further recognizes that these challenges are compounded by the distinct characteristics of each LLM. For instance, Generative Pre-trained Transformer (GPT) may be adept at generating human-like text, while Llama2™ might excel in analytical queries. This diversity means that a single prompt can yield different responses across various models, adding a layer of complexity for users frequently switching between LLMs. This can reduce efficiency by increasing the time it takes to recraft prompts that align with each model's specificities while introducing possible errors when attempting to recreate prompts. Furthermore, this rapid development cycle (e.g., constant state of evolution with new models emerging) makes it increasingly difficult for users to stay abreast of the most effective interaction methods with these ever-changing models.

Embodiments of the present invention recognize that current solutions primarily focus on enhancing outputs from individual LLMs through prompt pre-processing or output post-processing. However, these solutions fall short in addressing model-specific behavior nuances and the need for prompt portability across various LLMs. Furthermore, these solutions typically lack a feedback mechanism for continuous adaptation based on real-world usage and user feedback.

Recognizing these problems, embodiments of the present invention provide solutions capable of simplifying user interactions with diverse LLMs. For example, embodiments of the present invention address this gap by introducing a virtualization layer that not only automates the prompt tailoring process for optimal responses from selected LLMs but also offers the flexibility to adjust to different LLMs seamlessly. This provides users with an intuitive system that requires minimal understanding of the intricacies of each LLM, thus significantly enhancing the user experience. As discussed in greater detail later in this Specification, embodiments of the present invention include a model selector, prompt tailoring engine, and feedback loop (i.e., feedback mechanism) that, when executed, provide a comprehensive solution in the rapidly evolving domain of LLM interactions, ensuring both immediate efficacy and long-term relevance.

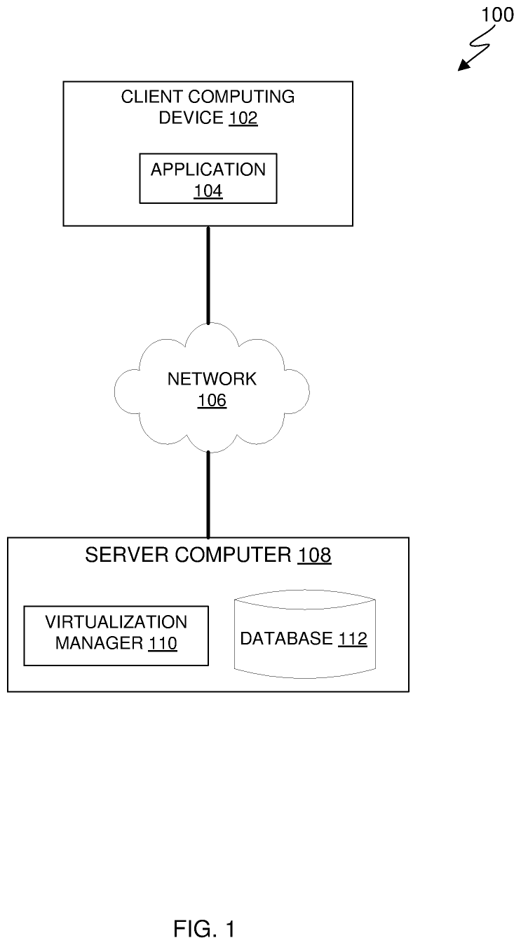

FIG. 1 is a functional block diagram illustrating a computing environment, generally designated, computing environment 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

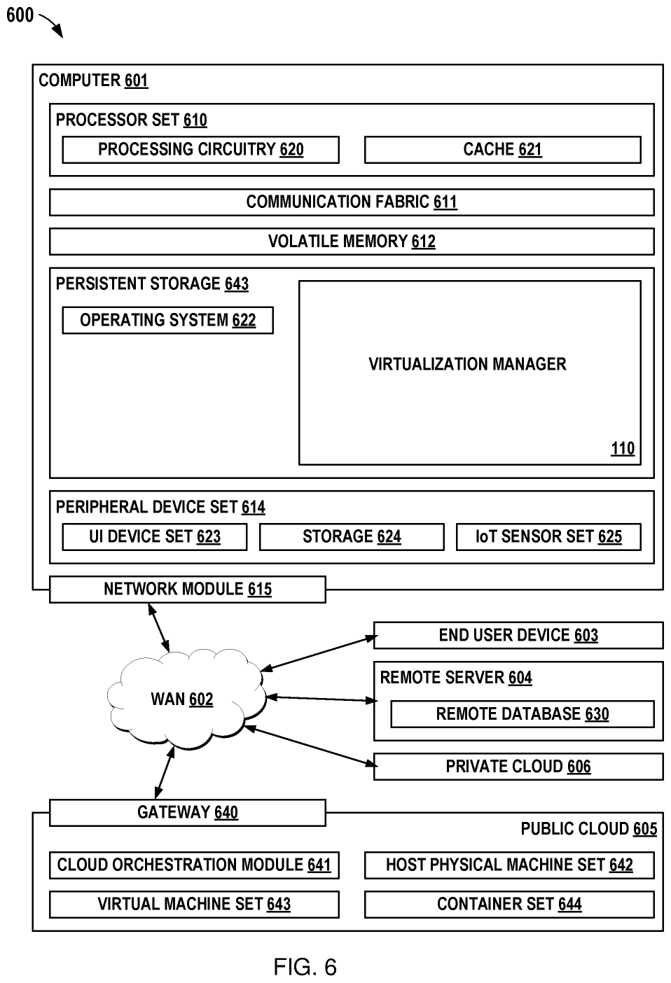

Computing environment 100 includes client computing device 102 and server computer 108 interconnected over network 106. Client computing device 102 and server computer 108 can be a standalone computer device, a management server, a webserver, a mobile computing device, or any other electronic device or computing system capable of receiving, sending, and processing data. In other embodiments, client computing device 102 and server computer 108 can represent a server computing system utilizing multiple computers as a server system, such as in a cloud computing environment. In another embodiment, client computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, client computing device 102 and server computer 108 each represent a computing system utilizing clustered computers and components (e.g., database server computers, application server computers, etc.) that act as a single pool of seamless resources when accessed within computing environment 100. In some embodiments, client computing device 102 and server computer 108 are a single device. Client computing device 102 and server computer 108 may include internal and external hardware components capable of executing machine-readable program instructions, as depicted and described in further detail with respect to FIG. 6.

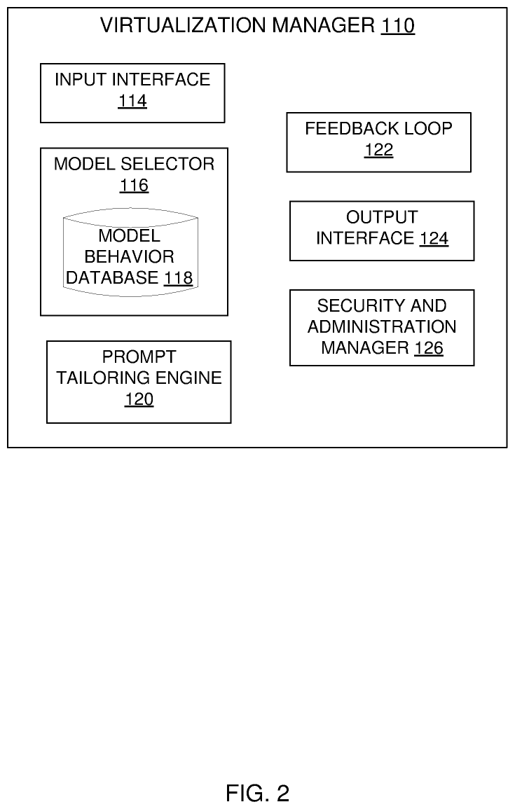

In this embodiment, client computing device 102 is a user device associated with a user and includes application 104. Application 104 communicates with server computer 108 to access virtualization manager 110 (e.g., using TCP/IP) to access user information and database information. In this embodiment, application 104 receives permissioned access to user information and database. For example, application 104 can provide a user an opt-in/opt-out notification before accessing user information and database information. Application 104 can further communicate with virtualization manager 110 to enhance interactions between end users and Large Language Models, as discussed in greater detail in FIGS. 2-5. In this embodiment, client computing device 102 can be used to monitor and record changes to file paths of one or more files in other computing systems.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among client computing device 102 and server computer 108, and other computing devices (not shown) within computing environment 100.

Server computer 108 is a digital device that hosts virtualization manager 110 and database 112. In this embodiment, virtualization manager 110 resides on server computer 108. In other embodiments, virtualization manager 110 can have an instance of the program (not shown) stored locally on client computing device 102. In other embodiments, virtualization manager 110 can be a standalone program or system that can be integrated in one or more computing devices having a display screen.

Virtualization manager 110 provides capabilities for adaptive prompt virtualizing for optimized interactions with multiple LLMs. Virtualization manager 110 offers a flexible, model-agnostic approach to prompt tailoring, enabling users to either choose a specific LLM or utilize the system's automated selection for the most suitable LLM based on the prompt. This novel approach promotes effective response elicitation and enables prompt portability across different LLMs.

Virtualization manager 110 includes a model selector (not shown), a model behavior database (not shown), a prompt tailoring engine, and a feedback loop as discussed in greater detail with respect to FIG. 2. In general, virtualization manager 110 utilizes one or more of these components to determine the most suitable LLM for each prompt based on real-time analysis, and detailed meta-information, refine and customize user prompts, and continually improve recommendations.

In contrast to existing methods primarily focused on improving outputs from individual LLMs, virtualization manager 110 adopts a holistic, multi-model approach. For example, virtualization manager 110 not only addresses the subtleties of model-specific behaviors but also pioneers the concept of prompt portability, a critical aspect often overlooked in current solutions. This significantly alleviates the need for manual prompt adjustments by end-users when switching between different LLMs, thereby boosting efficiency and effectiveness.

Virtualization manager 110 improves existing solutions by providing a comprehensive strategy for managing the distinct characteristics of various LLMs. In this manner, virtualization manager 110 provides solutions that offer a comprehensive strategy for managing the distinct characteristics of various LLMs. The integration of a feedback loop, grounded in reinforcement learning, further ensures its suitability and relevance amidst the rapidly changing LLM landscape. Features such as the ability for users to store prompts in a model-independent manner, select different models, and provide feedback for continuous improvement, improve existing solutions in the realm of LLM interaction and optimization.

Database 112 stores received information and can be representative of one or more databases that give permissioned access to virtualization manager 110 or publicly available databases. In general, database 112 can be implemented using any non-volatile storage media known in the art. For example, database 112 can be implemented with a tape library, optical library, one or more independent hard disk drives, or multiple hard disk drives in a redundant array of independent disk (RAID). In this embodiment database 112 is stored on server computer 108.

FIG. 2 depicts a block diagram of certain components of a virtualization manager, in accordance with an embodiment of the present invention.

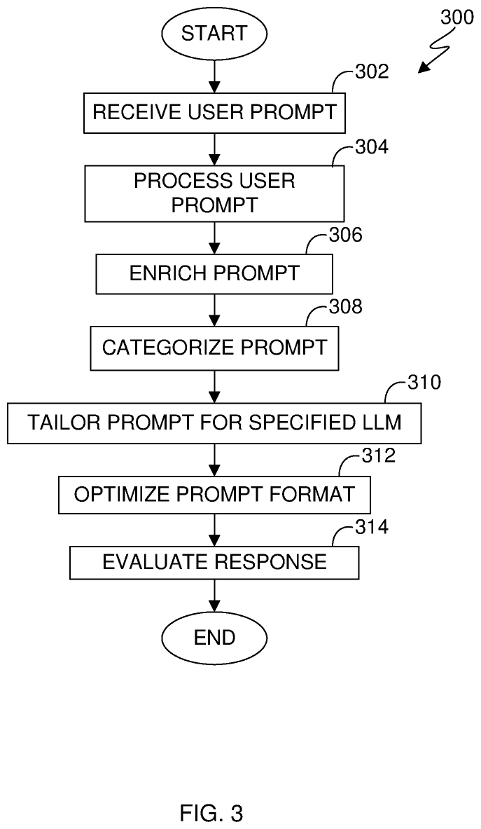

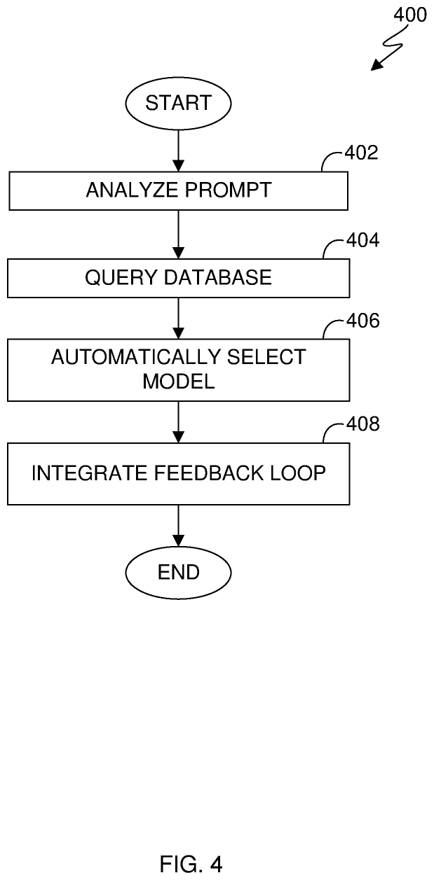

Virtualization manager 110 can be offered as a part of or otherwise integrated in a virtualization layer tailored for enhancing interactions between users and a variety of Large Language Models (LLMs). This layer is designed to function in two primary modes, each utilizing the same foundational components but executing different processes to meet specific objectives. Mode 1 is centered on virtualizing prompts to be effective across multiple LLMs, focusing on prompt enrichment and adaptation for optimal model-agnostic responses. Mode 2, conversely, employs an automated selection process to identify the most suitable LLM for a given prompt, optimizing response quality based on the model's unique strengths and historical performance as discussed in greater detail regarding FIGS. 3 and 4.

Virtualization manager 110 includes input interface 114, model selector 116, model behavior database 118, prompt tailoring engine 120, feedback loop 122, output interface 124, and security and administration manager 126. In this embodiment, input interface 114 collects received queries and manages received context. In other words, input interface 114 captures the raw query or prompt that the user inputs. In this embodiment, input interface can receive text, voice, or other forms of input based on how the virtualization layer is deployed. For example, input interface 114 can include a text box in a web interface, a microphone icon in a mobile application, or a voice-capture mechanism in a voice-assistant context.

In some embodiments, input interface 114 includes a context manager (not shown) to keep track of user's conversation history or other relevant contextual data that could affect the tailoring of the prompt. Input interface 114 can employ various storage methods, from in-memory databases to more persistent solutions, depending on the application's needs. Examples of logs (i.e., history) input interface can maintain include previous queries, responses, and even metadata like the time of interaction or user preferences. In this manner, input interface 114 can provide suggestions to the prompt tailoring and LLM selection process, making it more dynamic and adaptive to the user's ongoing needs. By synthesizing information from the received prompts a context, input interface 114 delivers a comprehensive query package that serves as the input for the subsequent components in the architecture.

Model selector 116 acts as a gatekeeper to the LLMs, ensuring that queries are routed to the models most capable of handling them effectively which optimizes the use of computational resources by avoiding unnecessary query processing by less suitable models. Model selector 116 includes a model behavior database (e.g., model behavior database 118). Model selector 116 uses model behavior database 118 to algorithmically determine the most suitable LLM for each prompt, based on real-time analysis and detailed meta-information.

Model behavior database 118 serves as a repository containing meta information about various Large Language Models (LLMs) available for selection that is synthesized from having permissioned access to various sources, including model documentation like data cards and model cards, to create a comprehensive and accurate representation of each Large Language Model (LLM)'s capabilities and characteristics. This meta information can include training data that reflects a range and variety of data each model was trained on which can impact its general knowledge and domain-specific expertise. Meta information can also include model specific information (i.e., specialized capabilities) such as the model's strengths, weaknesses, specific nuances, and even historical performance data. For example, meta information can include information that identifies models fine-tuned for specific tasks such as summarization, sentiment analysis, or technical coding. Meta information can also include response styles of certain models (e.g., succinct and factual versus narrative and elaborate), input adaptability (i.e., how models handle different types of prompts ranging from zero-shot to few-shot scenarios), and areas for support (e.g., domains or types of prompts where a model might need additional support to generate quality responses). An example entry in model behavior database 118 is reproduced below:

| Model | Training | | Response | Input | Areas for |
|---|---|---|---|---|---|
| Name | Diversity | Specialization | Style | Adaptability | Support |
| GPT-3 | Global, | Creative | Narrative | Few-shot | Technical |
| | Varied | Writing | | | Detail, Precision |
| BERT ™ | Academic, | Semantic | Concise | Zero-shot | Narrative, |
| | Focused | Analysis | | | Creative Tasks |
| Llama2 ™ | Diverse | Summary, | Balanced | Few-shot | Deep Technical |
| | | Sentiment | | | Analysis |
| Granite | Technical | Code, | Technical | Zero-shot | General |
| | | Programming | | | Knowledge, |
| | | | | | Creativity |

### Example Database Entry 1

Virtualization manager 110 can leverage this entry to tailor prompts effectively for a user-specified LLM. Model selector 116 can leverage model behavior database 118 to identify that one model excels at technical queries while another is better for conversational or creative tasks. For instance, virtualization manager 110 can receive a prompt that requires deep technical analysis and enrich the received prompt with additional context and structured queries to compensate for Llama2's identified need for support in this area. Similarly, for BERT, virtualization manager 110 can structure creative or narrative elements to be more analytical to align with its strengths while addressing its areas for support. Virtualization manager 110 can be implemented using a variety of storage solutions, from relational databases to NoSQL options, and would likely need to be updated regularly as new LLMs become available or existing ones are updated.

In some embodiments, model selector 116 also includes a selection algorithm (not shown). This is the logic layer that chooses the most appropriate LLM based on the user's query and any other influencing factors like context or user-defined criteria. The algorithm takes the processed input from input interface 114 and queries model behavior database 118 to make an informed decision. Model selector 116 can employ a range of techniques, from basic rule-based systems to more complex machine learning models, to make this choice. The key is to select an LLM that is most likely to produce a high-quality response to the specific query at hand.

Prompt tailoring engine 120 includes one or more natural language understanding algorithms to refine and customize user prompts to align with specific strengths of the selected LLM. In certain embodiments, the natural understanding algorithms (i.e., natural language understanding modules) parses the query to extract its semantics, intent, and important keywords or phrases. In this embodiment, prompt tailoring engine can utilize advanced natural understanding techniques such as named entity recognition, sentiment analysis, or even dependency parsing could be employed here. In this manner, prompt tailoring engine 120 can understand what the user is asking for on a deeper level so that the prompt can be tailored effectively for the chosen LLM.

In certain embodiments, prompt tailoring engine 120 can include one or more tailoring algorithms. These are the algorithms responsible for adapting the user's query to better match the specific characteristics of the selected LLM. Depending on the LLM's strengths and weaknesses, as identified by model behavior database 118, prompt tailoring engine 120 can utilize tailorizing algorithms to apply various adaptations. For example, adaptations can include adding few-shot examples, modifying the tone, or even rephrasing the query entirely.

In other embodiments, prompt tailoring engine 120 can include a pre-prompt repository (not shown). The pre-prompt repository is a database containing pre-engineered prompts or segments of prompts that are known to produce effective responses from specific LLMs. Virtualization manager 110 can utilize this repository to speed up the tailoring process by providing ready-to-use templates or building blocks. For example, if a certain prompt structure has been found to elicit highly accurate answers from a technical LLM, prompt tailoring engine 120 can utilize this structure stored in the pre-prompt repository.

Feedback loop 122 includes a response evaluator (not shown), a user feedback collector (also not shown), and a learning algorithm to continuously improve and refine the effectiveness of tailored responses and adapt the process based on user feedback and performance evaluations. After an LLM generates a response, feedback loop 122 can leverage a response evaluator to evaluate its effectiveness based on pre-defined criteria or metrics, such as relevance, completeness, or accuracy. In this embodiment, the criteria used by feedback loop 122 can be tailored to the type of query or the specific use-case. In some embodiments, feedback loop 122 can utilize machine learning models trained on past data could be used to automatically gauge the quality of responses. Feedback loop 122 can feed the outcome of this evaluation into a learning algorithm for iterative improvements.

In some embodiments, feedback loop 122 can include a user feedback collector that captures user input about the utility and relevance of the LLM's response. For example, feedback loop 112 can generate a user interface that displays graphic icons that, when selected, could convey a user's approval or disapproval via a thumbs-up or thumbs-down button. In other embodiments, the generated user interface can send a survey to users. In this manner, any collected user feedback can provide an additional data source for the Learning Algorithm, offering a direct measure of user satisfaction and response quality.

In embodiments that include a learning algorithm, feedback loop 122 can update algorithms by updating model behavior database 118. For example, feedback loop 112 can update algorithms selected by model selector 116 and prompt tailoring engine 120 based on user evaluations and user feedback. By continuously refining these algorithms, virtualization manager 110 becomes increasingly effective at routing queries to the appropriate LLMs and tailoring prompts for optimal results. In this way, virtualization manager 110 can utilize a form of closed-loop system where each interaction helps improve future interactions. In this embodiment, the learning algorithm can utilize various techniques that include reinforcement learning, supervised learning, or even rule-based updates.

Output interface 124 ensures that the final response is both accurate and user-friendly. It bridges the gap between the complex internal workings of the virtualization layer and the end-user, making the entire process seamless and efficient. In other words, output interface 124 formats and delivers a selected LLM's response to the user. In some embodiments, output interface can include a response formatter (not shown) that transform output from the selected LLM according to predetermined rules or user-defined preferences. For example, output interface 124 can leverage the response formatter to modify the output and change the output from a detailed answer to a summary or bullet points based on user preferences.

Output interface 124 can generate results that are subsequently displayed on a user interface. For example, output interface 124 can display results that are displayed on a screen, spoken through a voice assistant, or even sent as a text message or email. In other embodiments, the generated results can be configured to be displayed across multiple platforms and media types to ensure maximum usability.

Security and administration manager 126 the model behavior database serves as a comprehensive repository, cataloging the unique characteristics and capabilities of various Large Language Models (LLMs). In some embodiments, security and administration manager 126 can utilize a dashboard and analytics module for overseeing the system's operations and performance. In this way, security and administration manager 126 provides real-time monitoring capabilities, offering insights into system performance, active user queries, and LLM responses.

Security and administration manager 126 can utilize an authentication and data privacy manager to ensure that only authorized users and applications can interact with the system, using methods such as passwords, tokens, or even multi-factor authentication. Security and administration manager 126 can utilize the data privacy manager to ensure secure data practices. For example, security and administration manager 126 can encrypt sensitive information, manage user consent for data usage, and ensure compliance with relevant laws and regulations.

FIG. 3 is a flowchart 300 depicting operational steps for virtualizing a received prompt, in accordance with an embodiment of the present invention. In this embodiment, virtualization manager 110 focuses on virtualizing prompts to ensure their effectiveness across various LLMs. Virtualization manager 110 achieves this by enriching and adapting the prompt structure to align with the known behaviors and strengths of different models. For this embodiment, also referenced as “Mode 1”, virtualization manager 110 maximizes the quality and relevance of the output by creating a prompt that is model-agnostic and can elicit optimal responses from any selected LLM.

In step 302, virtualization manager 110 receives a user prompt. In this embodiment, virtualization manager 110 can receive a user prompt from application 104. In other embodiments virtualization manager 110 can receive a user prompt from one or more other components of computing environment 100. In this embodiment a user prompt can include a user request to perform a task. In some embodiments a task can be a query to retrieve information. For example, a user prompt can include a query to location information (e.g., innovations in electric vehicle technology). In this embodiment, virtualization manager 110 can receive a user prompt via text or voice.

In step 304, virtualization manager 110 processes the received user prompt. In this embodiment, virtualization manager 110 processes the received user prompt using a natural language understanding module that utilizes advanced algorithms for in-depth semantic analysis and entity recognition. In this embodiment, virtualization manager 110 utilizes tools such as Bidirectional Encoder Representations from Transformers (BERT) for semantic understanding and an open source software library for advanced natural language processes written in Python and Cython for named entity recognition. Continuing the above example, virtualization manager 110 can identify “innovations” and “electric vehicle technology” and can discern the informational intent.

In step 306, virtualization manager 110 enriches context of the received user prompt. In this embodiment, virtualization manager 110 enriches context by referencing a context database that maintains records of each user's interaction history that includes past prompts and responses and integrating past prompts and interactions. In this manner, virtualization manager 110 can incorporate past user interactions into the received user prompt. Continuing the above example, virtualization manager 110 can generate an enhanced prompt to state, “Considering interest in sustainable technologies, what are the latest innovations in electric vehicle technology?”

In step 308, virtualization manager 110 categorizes prompt. In this embodiment, virtualization manager 110 categorizes the enriched user prompt into specific domains and styles. In this embodiment, virtualization manager 110 categorizes the enriched user prompt based on content, style, and complexity identified from natural language understanding. For example, virtualization manager 110 classifies the enriched user prompt as“technological innovations” and “sustainable technology”.

In step 310, virtualization manager 110 tailors prompt for specified LLM. In this embodiment, virtualization manager 110 tailors prompts based on specific characteristics and API requirements for a specified LLM by querying model behavior database 118. For example, in response to a user selecting an LLM such as Llama2™ or GPT-3, virtualization manager 110 can retrieve characteristic information for each of those respective LLMs. Specifically, for Llama2™, virtualization manager 110 can retrieve information that includes: Specialization: Summary, Sentiment Analysis; Areas for Support: Deep Technical Content; Response Style: Balanced; Input Adaptability: Few-shot. For GPT-3, virtualization manager 110 can retrieve the following information: Specialization: Summary, Sentiment Analysis; Areas for Support: Deep Technical Content; Response Style: Balanced; Input Adaptability: Few-shot.

Virtualization manager 110 can then tailor the prompt based on the specific characteristics and API requirements. For example, when tailoring for Llama2™, virtualization manager 110 aligns the prompt with its documented strengths in the model behavior database 118, particularly in handling “Technological Innovations”. Virtualization manager 110 identifies Llama2™ as having capabilities to summarize complex, technical topics effectively and its preference for detailed contexts. Leveraging advanced NLP techniques, specifically employing an LLM, virtualization manager 110 constructs a tailored prompt that provides a thorough yet concise overview of a technical subject. For example, virtualization manager 110 can tailor the prompt which results in an updated prompt such as “Outline the key technological advancements in renewable energy and their potential urban applications,” to highlight Llama2's summarization skills, with specific mentions of “technological advancements” and “urban applications” to satisfy its preference for rich, detailed context.

In another example, where GPT-3 is selected, virtualization manager 110 aligns the prompt with its documented strengths (e.g., strengths in creative writing and narrative responses, as identified in its ‘Creative Writing’ categorization) in the model behavior database 118. Here, virtualization manager 110 utilizes advanced NLP, again through an LLM, to develop a prompt that encourages GPT-3's creative narrative abilities. In the example, virtualization manager 110 generates the following prompt: Narrate a scenario where renewable energy technologies revolutionize urban living in 2040. This generated prompt is designed to engage GPT-3's storytelling ability. This prompt encourages GPT-3 to explore creative, futuristic scenarios, aligning with its narrative style while compensating for its less succinct factual response tendency.

In step 312, virtualization manager 110 optimizes prompt format. In this embodiment, virtualization manager 110 tailors the prompt by formatting the prompt to align with the specific API requirements of the chosen LLM. For example, virtualization manager 110 formats the prompt by setting parameters in the API request that cater to the model's input adaptability and response style, as documented in the database. In this way, virtualization manager 110 ensures that the prompt is presented in a way that maximizes the model's response efficiency and quality.

In step 314, virtualization manager 110 evaluates response. In this embodiment, virtualization manager 110 evaluates the response generated by the LLM, processes the optimized prompt, and evaluates the quality and relevance of the generated response. In this embodiment, virtualization manager 110 evaluates the response based on its accuracy, completeness, and how well the response satisfies the user's request. For example, virtualization manager 110 evaluates the response by collecting user feedback, adapting and learning from the collected user feedback, and updating the model behavior database based on the collected user feedback. In this example, virtualization manager 110 can iteratively perform this feedback loop (e.g., collecting user feedback, adapting and learning, and updating the model behavior database) to further refine its' suggestions.

In this embodiment, virtualization manager 110 collects user feedback directly from the user regarding their satisfaction with the response. Virtualization manager 110 collects user feedback in the form of ratings, comments, or specific indicators of response utility. For example, virtualization manager 110 can generate and subsequently send a survey to the user and collect user responses (e.g., a user rates the usefulness of the response to the tailored prompt: “Outline the key technological advancements in renewable energy and their potential urban applications”). In this embodiment, virtualization manager utilizes a numeric rating scale to evaluate the tailored prompt where lesser numbers indicate a lower rating and greater numbers indicate a higher (i.e., better) rating (e.g., a numeric scale from one to five where five indicates the highest level of user satisfaction).

In this embodiment, virtualization manager 110 adapts and learns from the collected user feedback by integrating the collected user feedback into model behavior database 118. Virtualization manager 110 uses the collected data to update and refine the algorithms of model selector 116 and prompt tailoring engine 120. For example, if responses to prompts tailored for Llama2™ consistently receive high user ratings for summaries but lower ratings for technical details, virtualization manager 110 adjusts its tailoring approach to enhance the technical aspect in future prompts. In this manner, virtualization manager 110 can continuously ensure model behavior database 118 reflects the most current and accurate information about each model's performance and user preferences. In some instances, virtualization manager 110 can update profiles associated with LLMs to emphasize a need for more detailed technical context based on user feedback and response evaluations.

FIG. 4 is a flowchart 400 depicting operational steps for automatically selecting a model, in accordance with an embodiment of the present invention. By performing the operational steps of flowchart 400, virtualization model 110 automatically selects the most suitable LLM for a given prompt based on its characteristics functioning in an alternate mode (also referred to as Mode 2). Stated another way, virtualization manager 110 can analyze a received prompt and automatically match the received prompt with the most suitable LLM.

In step 402, virtualization manager 110 analyzes prompts. In this embodiment, virtualization manager 110 analyzes received prompts utilizing Natural Language Understanding (NLU) techniques to analyze the prompt's content and context. For example, virtualization manager 110 can receive a prompt that containing the following text: Provide a historical overview of renewable energy advancements. Virtualization manager 110 can then categorize the received prompt based on its characteristics, such as “historical analysis” and “renewable energy.”

In step 404, virtualization manager 110 queries databases. In this embodiment, virtualization manager 110 queries model behavior database 118 to retrieve relevant information about potential models. In this embodiment, relevant information can include a model's specialization in historical content, response style, and input adaptability. For example, Virtualization manager 110 can query model behavior database 118 and receive the following result that indicates that Llama2™ is adept at summarizing historical content with a balanced response style, making it a suitable choice.

In step 406, virtualization manager 110 automatically selects models. In this embodiment, virtualization manager 110 automatically selects model using one or more algorithms to select an LLM that best aligns with the prompt's requirements, informed by the database query results and the prompt's categorization. In this embodiment, virtualization manager 110 considers factors such as the model's strengths, response style, and how well it can handle the specific type of prompt. In other embodiments, virtualization manager 110 can assign weighted values to each factor that it considers and select an LLM having the highest weighted score. In these embodiments, virtualization manager 110 can utilize a numeric scale where lower numbers indicate a lesser value and higher numbers indicate a greater value.

In step 408, virtualization manager 110 integrates the selection into the feedback loop. In this embodiment, virtualization manager 110 integrates the selection into the feedback loop by collecting user feedback directly from the user regarding their satisfaction with the response in the form of ratings, comments, or specific indicators of response utility. In this manner, virtualization manager 110 can continuously update model behavior database 118.

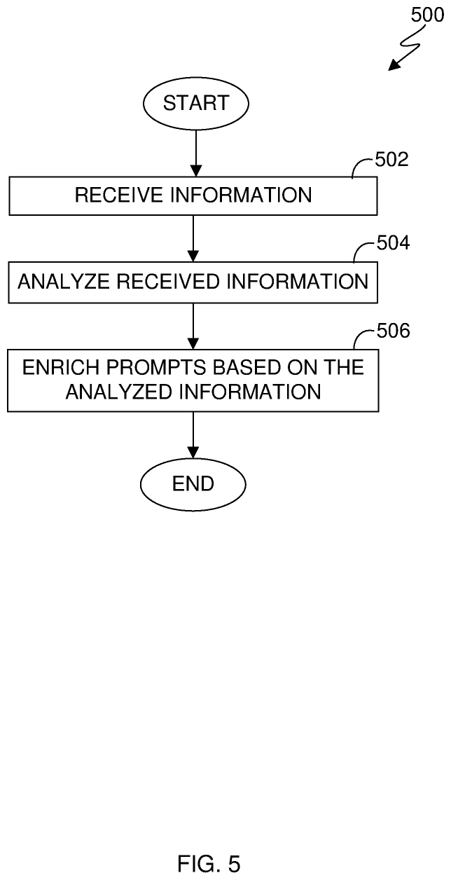

FIG. 5 is a flowchart 500 depicting alternate operational steps for virtualizing a received prompt, in accordance with an embodiment of the present invention.

In step 502, virtualization manager 110 receives information. In this embodiment, virtualization manager 110 receives information from application 104. Received information includes a user prompt. User prompts can include text specifying a query to retrieve information or a task to perform one or more functions. For example, virtualization manager 110 can receive a user prompt that specifies a query that requests innovations in electric vehicle technology. In some embodiments, user prompts can also include media files (e.g., photos, audio, video, etc.) along with text instructions. User prompts can include additional text that specifies what function or model the user prefers. In other embodiments virtualization manager 110 can receive information from one or more other components of computing environment 100.

In step 504, virtualization manager 110 analyzes prompts. In this embodiment, virtualization manager 110 analyzes prompts using a natural language understanding module that utilizes advanced algorithms for in-depth semantic analysis and entity recognition to identify intent (e.g., a query to retrieve information or perform a particular task) and categorize the received prompt. In this embodiment, virtualization manager 110 utilizes tools such as Bidirectional Encoder Representations from Transformers (BERT) for semantic understanding and an open source software library for advanced natural language processes written in Python and Cython for named entity recognition. Virtualization manager 110 can categorize a received prompt according to subject matter identified during the analysis of the received prompt.

In step 506, virtualization manager 110 enriches the analyzed prompts. In this embodiment, virtualization manager 110 enriches the analyzed prompts by referencing a context database that maintains records of each user's interaction history that includes past prompts and responses and integrating past prompts and interactions. For example, virtualization manager 110 can enrich the analyzed prompt to specify a question that incorporates a user's past interactions (e.g., considering user interest in sustainable technology, what are the latest innovations in electric vehicle technology?). In this manner, virtualization manager 110 can incorporate past user interactions to provide context for the received user prompt and adapt the received prompt (i.e., adapting the prompt structure) for optimal model-agnostic responses.

In this embodiment, virtualization manager 110 can then categorize the enriched prompt. In this embodiment, virtualization manager 110 categorizes the enriched user prompt into specific domains and styles. In this embodiment, virtualization manager 110 categorizes the enriched user prompt based on content, style, and complexity identified from natural language understanding. For example, virtualization manager 110 classifies the enriched user prompt as “technological innovations” and “sustainable technology”.

Virtualization manager 110 can then adapt the received prompt for a specified LLM either manually or automatically. In this embodiment, virtualization manager 110 tailors prompts based on specific characteristics and API requirements for a specified LLM by querying model behavior database 118 in the same manner as described in FIG. 3. For example, in response to a user selecting an LLM such as Llama2™ or GPT-3, virtualization manager 110 can retrieve characteristic information for each of those respective LLMs and select Llama2™ as having capabilities to summarize complex, technical topics effectively and its preference for detailed contexts. Leveraging advanced NLP techniques, specifically employing an LLM, virtualization manager 110 constructs a tailored prompt that provides a thorough yet concise overview of a technical subject. For example, virtualization manager 110 can tailor the prompt which results in an updated prompt such as “Outline the key technological advancements in renewable energy and their potential urban applications,” to highlight Llama2's summarization skills, with specific mentions of “technological advancements” and “urban applications” to satisfy its preference for rich, detailed context.

FIG. 6 depicts an alternate block diagram of components of computing systems within computing environment 100 of FIG. 1, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as virtualization manager 110 (also referred to as block 110) which provides adaptive prompt virtualization for optimized interactions with multiple LLMs as discussed previously with respect to FIGS. 2-5.

In addition to block 110, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 110, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 110 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in block 110 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601) and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

What is claimed is:

1. A computer-implemented method comprising:
analyzing user prompts using one or more natural language understanding techniques;
enriching the user prompts by integrating contextual data from user interaction history; and
adapting the enriched user prompts to align with characteristics of Large Language Models (LLMs) and Application Programming Interfaces (API) requirements of the LLMs.

2. The computer-implemented method of claim 1, further comprising:
collecting received user prompts and contextual information associated with the received user prompts; and
tailoring the received user prompts for a respective LLM of the respective LLMs based on characteristics of each respective LLM.

3. The computer-implemented method of claim 2, further comprising:
formatting the tailored user prompts to align with the respective LLM.

4. The computer-implemented method of claim 2, further comprising:
categorizing the enriched user prompts based on its characteristics into specific domains and styles using natural language processing;
matching the categorized prompts with a subset of LLMs of the respective LLMs by querying a model behavior database; and
algorithmically selecting an optimal LLM from the subset of LLMs based on the user's prompts.

5. The computer-implemented of claim 4, further comprising:
automatically selecting an optimal Large Language Model from the LLMs based on user prompts, contextual information associated with the user prompts, and characteristics of the enriched user prompt.

6. The computer-implemented method of claim 2, further comprising:
evaluating effectiveness of the tailored user prompts by integrating a feedback loop mechanism.

7. The computer-implemented method of claim 6, further comprising:
updating a model behavior database based on context provided by users and the evaluated effectiveness of the tailored user prompts.

8. A computer program product comprising:
one or more computer readable storage media and program instructions stored on the one or more computer readable storage media, the program instructions comprising:
program instructions to analyze user prompts using one or more natural language understanding techniques;
program instructions to enrich the user prompts by integrating contextual data from user interaction history; and
program instructions to adapt the enriched user prompts to align with characteristics of Large Language Models (LLMs) and Application Programming Interfaces (API) requirements of the LLMs.

9. The computer program product of claim 8, wherein the program instructions stored on the one or more computer readable storage media further comprise:
program instructions to collect received user prompts and contextual information associated with the received user prompts; and
program instructions to tailor the received user prompts for a respective LLM of the respective LLMs based on characteristics of each respective LLM.

10. The computer program product of claim 9, wherein the program instructions stored on the one or more computer readable storage media further comprise:
program instructions to format the tailored user prompts to align with the respective LLM.

11. The computer program product of claim 9, wherein the program instructions stored on the one or more computer readable storage media further comprise:
program instructions to categorize the enriched user prompts based on its characteristics into specific domains and styles using natural language processing;
program instructions to match the categorized prompts with a subset of LLMs of the respective LLMs by querying a model behavior database; and
program instructions to algorithmically select an optimal LLM from the subset of LLMs based on the user's prompts.

12. The computer program product of claim 11, wherein the program instructions stored on the one or more computer readable storage media further comprise:
program instructions to automatically select an optimal Large Language Model from the LLMs based on user prompts, contextual information associated with the user prompts, and characteristics of the enriched user prompt.

13. The computer program product of claim 8, wherein the program instructions stored on the one or more computer readable storage media further comprise:
program instructions to evaluate effectiveness of the tailored user prompts by integrating a feedback loop mechanism.

14. The computer program product of claim 13, wherein the program instructions stored on the one or more computer readable storage media further comprise:
program instructions to update a model behavior database based on context provided by users and the evaluated program instructions to effectiveness of the tailored user prompts.

15. A computer system comprising:
one or more computer processors;
one or more computer readable storage media; and
program instructions stored on the one or more computer readable storage media for execution by at least one of the one or more computer processors, the program instructions comprising:
program instructions to analyze user prompts using one or more natural language understanding techniques;
program instructions to enrich the user prompts by integrating contextual data from user interaction history; and
program instructions to adapt the enriched user prompts to align with characteristics of Large Language Models (LLMs) and Application Programming Interfaces (API) requirements of the LLMs.

16. The computer system of claim 15, wherein the program instructions stored on the one or more computer readable storage media further comprise:
program instructions to collect received user prompts and contextual information associated with the received user prompts; and
program instructions to tailor the received user prompts for a respective LLM of the respective LLMs based on characteristics of each respective LLM.

17. The computer system of claim 16, wherein the program instructions stored on the one or more computer readable storage media further comprise:
program instructions to format the tailored user prompts to align with the respective LLM.

18. The computer system of claim 16, wherein the program instructions stored on the one or more computer readable storage media further comprise:
program instructions to categorize the enriched user prompts based on its characteristics into specific domains and styles using natural language processing;
program instructions to match the categorized prompts with a subset of LLMs of the respective LLMs by querying a model behavior database; and
program instructions to algorithmically select an optimal LLM from the subset of LLMs based on the user's prompts.

19. The computer system of claim 18, wherein the program instructions stored on the one or more computer readable storage media further comprise:
program instructions to automatically select an optimal Large Language Model from the LLMs based on user prompts, contextual information associated with the user prompts, and characteristics of the enriched user prompt.

20. The computer system of claim 15, wherein the program instructions stored on the one or more computer readable storage media further comprise:
program instructions to evaluate effectiveness of the tailored user prompts by integrating a feedback loop mechanism.
